(19) United States
(12) Patent Application Publication
(10) Pub. No.: US 2017/0329543 A1
(43) Pub. Date: Nov. 16, 2017

(54) DATA RESTORATION USING BLOCK DISK PRESENTATIONS

(71) Applicant: HEWLETT PACKARD ENTERPRISE DEVELOPMENT LP, Houston, TX (US)

(72) Inventors: Alastair Slater, Bristol (GB); Siamak Nazari, Fremont, CA (US)

(73) Assignee: HEWLETT PACKARD ENTERPRISE DEVELOPMENT LP, Houston, TX (US)

(21) Appl. No.: 15/519,989

(22) PCT Filed: Oct. 22, 2014
(86) PCT No.: PCT/US14/61801

§ 371 Date: Apr. 18, 2017

(51) Int. Cl. G06F 3/06; G06F 11/14; G06F 11/16; G06F 11/00

(52) U.S. Cl. CPC G06F 3/0619; G06F 11/16; G06F 11/1469; G06F 11/00; G06F 2201/84

(57) ABSTRACT

In one example, a method is described herein. The method includes generating a block device presentation, the block device presentation corresponding to a snapshot to be restored. The method also includes configuring disk transport drivers on a virtual machine to make the block device presentation accessible. The method further includes receiving a disk read request for a specified logical block address. The method also further includes mapping a disk logical address to a backup object logical byte offset range. The method also further includes returning a selected data corresponding to the specified logical block address to a target storage device.

### BACKGROUND

A data protection system can use snapshots to record the state of a computing system at a point in time onto a storage mechanism. A snapshot is a set of pointers that can be used to restore the state of a disk to the particular time that the snapshot was taken. For example, a base virtual volume can be used to store an initial state of a protected system to a disk array, and snapshot virtual volumes indicating differences from the base virtual volume can then be stored on the storage mechanism such as a disk array or data protection device. Once the snapshots are saved, the data can be backed up onto a storage device.

### BRIEF DESCRIPTION OF THE DRAWINGS

Certain example implementations are described in the following detailed description and in reference to the drawings, in which:

FIG. 1 is a diagram of an example server network, in accordance with an example implementation of the present techniques;

FIG. 2 is a block diagram of an example data restoration system, in accordance with an example implementation of the present techniques;

FIG. 3 is a block diagram of an example block device presentation, in accordance with an example implementation of the present techniques;

FIG. 4 is a process flow diagram of an example method of restoring data, in accordance with an example implementation of the present techniques;

FIG. 5 is a process flow diagram of an example method of restoring data using a block device presentation, in accordance with an example implementation of the present techniques; and

FIG. 6 is a block diagram showing an example non-transitory, machine-readable medium that stores code configured to provide a block device presentation, in accordance with an example implementation of the present techniques.

### DETAILED DESCRIPTION

In some systems, the data comprising the state of the computing system can be backed up to a deduplication store for efficient storage. A deduplication store can contain one or more backup objects. For example, a backup object can include data chunks that can be repeated or duplicated throughout the data representing the state of the computing system. In performing a restoration of a snapshot, data from the deduplicated backup is first written to a disk array so that one or more portions of the full backup can be selected for restoration. The selected portions can then be restored from the disk array. Typically, the selected portions are restored to some other resultant endpoint.

This disclosure describes techniques for restoring data directly from a deduplicated backup. To restore data from the deduplicated backup, a block device presentation is created from a snapshot. The block device presentation is a temporary, mountable image of a backup created using the techniques described herein. As used herein, the term “backup” refers to a full backup and any snapshots, and the term “backup object” refers to a deduplication unit in a deduplication storage device. The term “target” refers to the location to which the backup is to be restored. A backup residing in a storage device of a backup storage system and hosted in a data protection server can be used to restore data to a target server connected to a target storage system. In some implementations, the data can be restored directly from one or more backup objects of the deduplication storage device by modifying drivers to create a block device presentation of the backup. System resources are thereby conserved by avoiding the write of the entire backup to a disk array before restoring all or some of the data in the backup to the target disk.

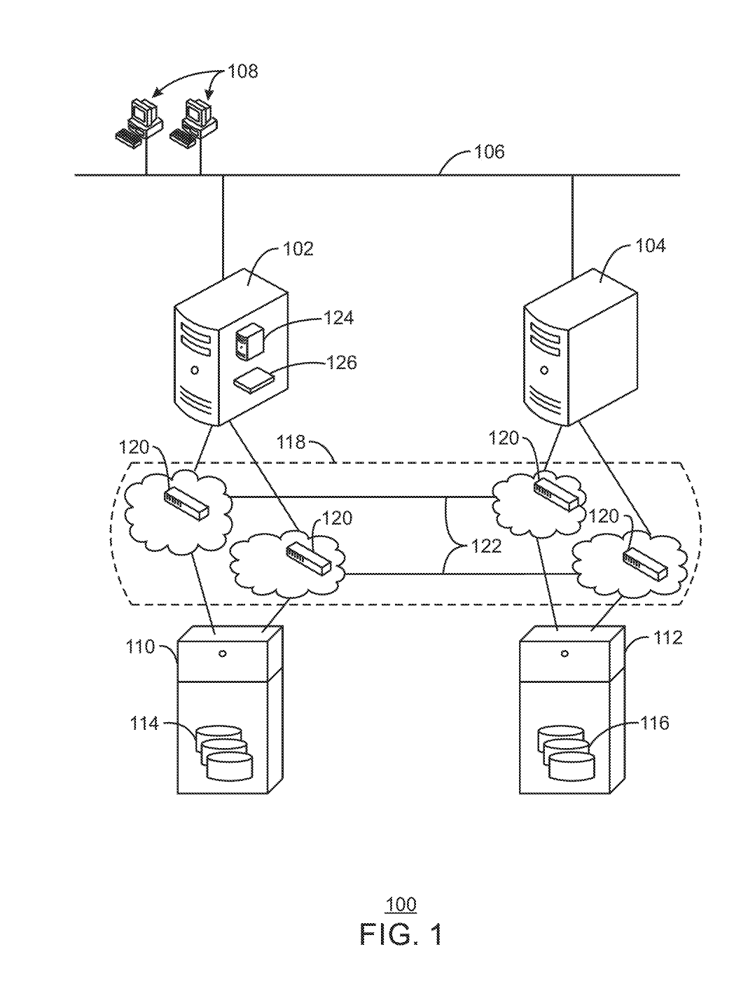

FIG. 1 is a diagram of a server network, in accordance with an example implementation of the present techniques. The server network is generally referred to by the reference number 100. As shown in FIG. 1, the server network 100 can include a backup server 102 and a target server 104 operatively coupled by a communications network 106, for example, a wide area network (WAN), local area network (LAN), virtual private network (VPN), the Internet, and the like. The communications network 106 can be a TCP/IP protocol network or any other appropriate protocol. Any number of clients 108 can access the servers 102, 104 through the communications network 106. Each server 102, 104 can also be operatively connected to a data storage system 110, 112 that includes storage devices 114, 116, such as an array of physical storage disks. The servers 102, 104 can access the data storage systems 110, 112 through a storage area network 118, which can include a plurality of switches 120 coupled by data links 122, for example, Ethernet interface connections, Fibre Channel links, SCSI (Small computer System Interface) interfaces, among others. In some examples, the data links 122 are part of the storage area network 118. Although physical connections are shown, the data links 122 can also include virtual links routed through the communications network 110, for example, using Fibre Channel over Ethernet (FCoE) or Fibre Channel over IP (FCIP).

A server 102 can host one or more virtual machines 124, each of which provides an operating system instance to a client 108. The clients 108 can access the virtual machine 124 in a location transparent manner. The storage data associated with the virtual machine 124 can be stored to the corresponding data storage system 110. In some examples, the virtual machine 124 running on the server 102 can reside on the data storage system 110.

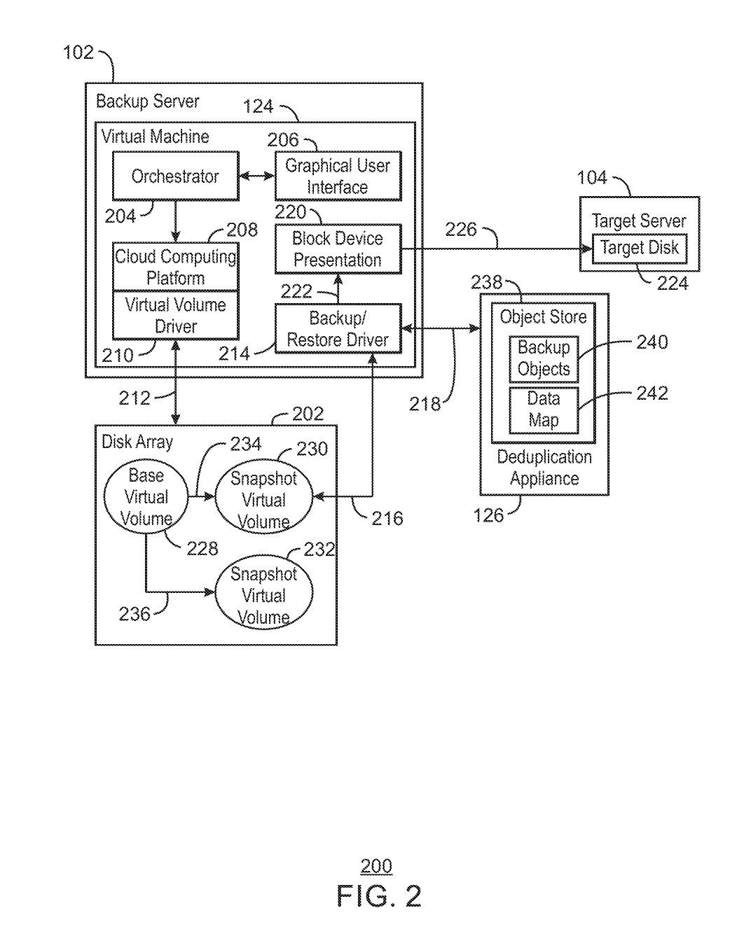

The server 102 also includes a block device presentation 126. The virtual machine 124 can restore data from a backup on one physical server 102 to another physical server 104. As described in relation to FIG. 2, the virtual machine 124 can create a block device presentation 126 using a data map. As described herein, a data map is a mapping between a snapshot space and a backup object space. The data map includes an order of backup objects, and the size of objects end-to-end to provide a logical block address space range. The data map can provide a capability to map a disk LBA request to an object byte range request for one or more objects. In some examples, the data map can be held as a metadata state with the individual backup objects. The block device presentation 126 can be used to restore all or some of the data in a backup to a storage device 116 of a data storage system 112 of a server 104.

It will be appreciated that the configuration of the server network 100 is but one example of a network can be implemented in an example implementation of the present techniques. The described server network 100 can be modified based on design considerations for a particular system. For example, a server network 100 in accordance with implementations of the present techniques can include any suitable number of physical servers 102, 104 and any suitable number of data storage systems 110, 112. Further, each server 102 can include one or more virtual machines 124, each of which can be operatively connected to one or more deduplication appliances 126 containing backups to be restored to any other suitable target servers 104. The block diagram of FIG. 1 is not intended to indicate that server network 100 is to include all of the components shown in FIG. 1. Further, the server network 100 can include any number of additional components not shown in FIG. 1, depending on the details of the specific implementation.

FIG. 2 is a block diagram of an example data restoration system, in accordance with an example implementation of the present techniques. The example backup restoration system is generally referred to by the reference number 200. As shown in FIG. 2, the backup server 102 includes a virtual machine 124. The backup server 102 is operatively connected to a disk array 202 and a deduplication appliance 126. The virtual machine 124 includes an orchestrator 204, a graphical user interface (GUI) 206, a cloud computing platform 208, and a virtual volume driver 210 to interface with a disk array 202 as shown by an arrow 212. The virtual machine 124 also includes a backup/restore driver 214 to interface with the disk array 202 and deduplication appliance 126 as indicated by arrows 216 and 218, respectively. The virtual machine 124 also includes a block device presentation 220 created by a backup/restore driver 214 as indicated by an arrow 222. The block device presentation 220 is to be communicated to a target disk 224 of a target server 104 via a data link 226. For example, the data link 226 can include an iSCSI, Fiber Channel, or any other high-speed data link. The disk array 202 can include a base virtual volume 228. The base virtual volume 228 is connected to snapshot virtual volumes 230, 232 of the disk array 202 as shown by arrows 234, 236, respectively. The deduplication appliance includes an object store 238. The object store 238 includes backup objects 240 and a data map 242.

The virtual machine 124 can be a virtual appliance. As used herein, a virtual appliance is a pre-configured virtual machine image that can be made available via electronic download or on a physical storage medium. The virtual machine 124 can be in the form of a virtual machine image for use with a hypervisor on the backup server 102. A hypervisor is a piece of computer software, firmware or hardware that can create and run virtual machines. The orchestrator 204 of the virtual machine 124 is used to schedule backups. For example, the orchestrator 204 may receive a backup request from the GUI 206 and send the backup request to the cloud computing platform 208. Backups can be scheduled via the GUI 206 to automatically execute at predetermined intervals, such as, once every day, once every week, or once every month. In some examples, the cloud computing platform 208 includes software used to provide logical volume management for snapshots in conjunction with a virtual volume driver 210. For example, the cloud computing platform 208 can provide disk array agnostic support such that a storage array from any particular vendor can be used. The virtual volume driver 210 can allow virtual volumes to be created on and read from the disk array 202. A virtual volume is a logical disk partition that can span across one or more physical volumes. A physical volume can include a hard disk, hard disk partition, or Logical Unit Numbers (LUNs) of an external storage device.

Still referring to FIG. 2, when an initial backup is performed, a base virtual volume 228 can be written to the disk array 202. The base virtual volume 216 can then serve as a base for a snapshot virtual volume 218 as indicated by an arrow 234 and as a base for snapshot virtual volume 222 as indicated by an arrow 236. For example, the snapshot virtual volumes 230, 232 can be backups of the same system at successive points in time. In some examples, the snapshots 230, 232 are implemented using copy-on-write techniques. In some examples, the disk array 202 uses thin disk provisioning for efficient use of disk space. For example, thin disk provisioning can include on-demand allocation of blocks of data and over-allocation of logical disk space.

The backup/restore driver 214 can allow the virtual machine 124 to interface with the snapshots 230, 232 of the disk array 202, such as a snapshot 230 as indicated by an arrow 216. For example, once a snapshot virtual volume 230 is created on the disk array 202, the backup/restore driver 214 can read the data bytes within the snapshot virtual volume 230 and send the data stream as a backup image in one or more backup objects 240 on an object store 238. The backup/restore driver 214 can use an application program interface (API) from the deduplication appliance 126 to perform source side deduplication on the data. For example, a chunk of data that is duplicated throughout a snapshot virtual volume 230 may be stored in a single backup object 240 of an object store 238. In some examples, chunk size is predetermined and adjustable. Thus, the backup restore driver 214 can allow the virtual machine 124 to interface with an object store 238 of deduplication appliance 126 as indicated by an arrow 218.

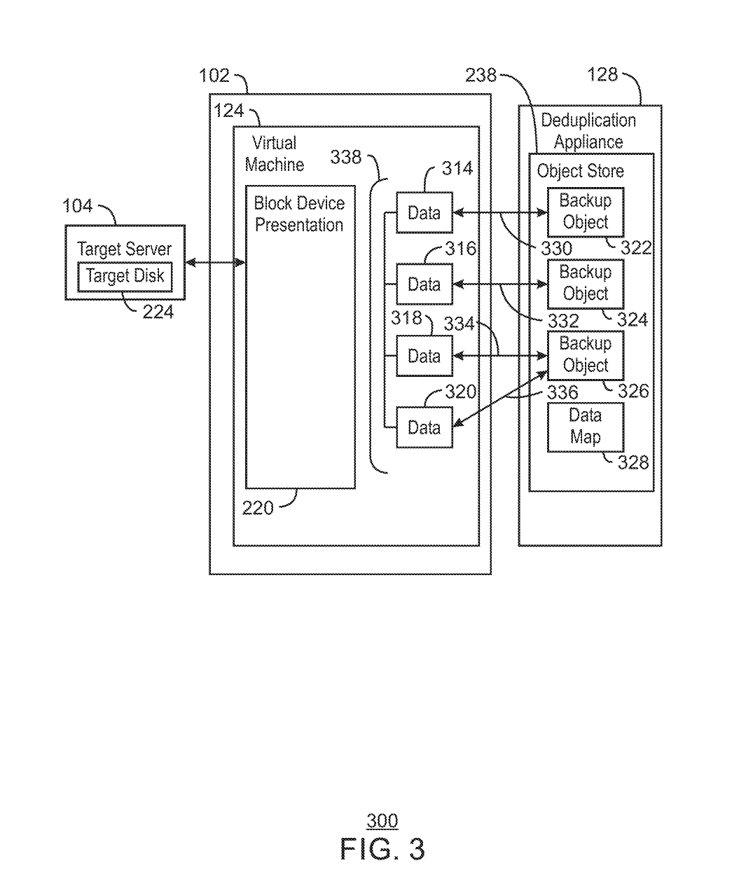

Still referring to FIG. 2, the backup/restore driver 214 can create a data map 242. A data map 242 is a mapping between two logical commodity spaces as described in greater detail in FIG. 3 below. For example, a first space can be a snapshot space at a disk source level and a second space can be a data object space at the data protection level of the deduplication appliance 126. In some examples, the backup/restore driver 214 saves the data map 242 onto the object store 238 of the deduplication appliance 126.

The backup/restore driver 214 can use the data map 242 to create a block device presentation 220. The block device presentation can be used to read and restore a snapshot 230, 232 of a system from one or more backup objects 240 to a target disk 224 via a data link 226. The block device presentation 220 can appear as a virtual disk that can be mounted by target server 104 as a read-only file system. The data represented by the block device presentation 220 can then be copied from the one or more backup objects 240 that form the block device presentation 220. Thus, time and disk resources are saved by reading data from the backup directly from the end point deduplication appliance 126 rather than first writing the data from backup objects back to a disk array to recreate a full backup on a disk array as discussed above. Moreover, after the restore is complete, the block device presentation 220 can be unmounted and removed from the virtual machine 124. Thus, the block device presentation 220 temporarily uses server resources in an efficient manner.

The block diagram of FIG. 2 is not intended to indicate that the backup restoration system 200 is to include all of the components shown in FIG. 2. Further, the backup restoration system 200 can include any number of additional components not shown in FIG. 2, depending on the details of the specific implementation.

FIG. 3 is a block diagram of an example block device presentation, in accordance with an example implementation of the present techniques. The example configuration of the block device presentation is referred to by the reference number 300. As shown in FIG. 3, a server 102 includes a virtual machine 124. The virtual machine 124 is communicatively coupled to a deduplication appliance 128. The virtual machine 124 includes a block device presentation that includes data objects 314, 316, 318, and 320. The deduplication appliance 128 contains an object store 238 having backup objects 322, 324, and 326 and a data map 328. The data object 314 is connected to a backup object 326 via an application program interface (API) 330 as indicated by an arrow 330. The data object 316 is connected to a backup object 324 via the API as indicated by an arrow 332. The data object 318 and the data object 320 are also connected to a backup object 326 via the API as indicated by arrows 334 and 336, respectively. The block device presentation 220 is also connected to a target disk 224 of a target server 104 via a data link 226. The block device presentation 220 is associated with the data blocks 314-320 as indicated by brace 338.

The block device presentation 220 can represent a snapshot composed of backup objects such as backup objects 322, 324 and 326. The virtual machine 124 can receive a read request from a target server 104 to read a portion of block device presentation 220. In some examples, the request to the block device presentation 220 uses the SCSI Block Command (SBC) command set. The virtual machine 124 can translate the read request into byte offsets and sizes represented by data objects 314, 316, 318, and 320. For each data object, the virtual machine 124 can make a request via the API for a corresponding backup object. For example, the backup object 322 may correspond to the data object 314 and the backup object 324 may correspond to the data object 316. In some examples, a backup object 326 corresponds to two or more data objects. For example, the backup object 326 can be a deduplicated backup object that corresponds to both data 318 and data 320. The API can return the backup object 326 for a corresponding request from both the data object 318 and the data object 320 as indicated by arrows 334 and 346. The requested data in the form of one or more backup objects can then be sent through a data link 226 to a target disk 224 of a target server 104 for restoration.

The block diagram of FIG. 3 is not intended to indicate that the server 102 is to include all of the components shown in FIG. 3. Further, the server 102 can include any number of additional components not shown in FIG. 3, depending on the details of the specific implementation.

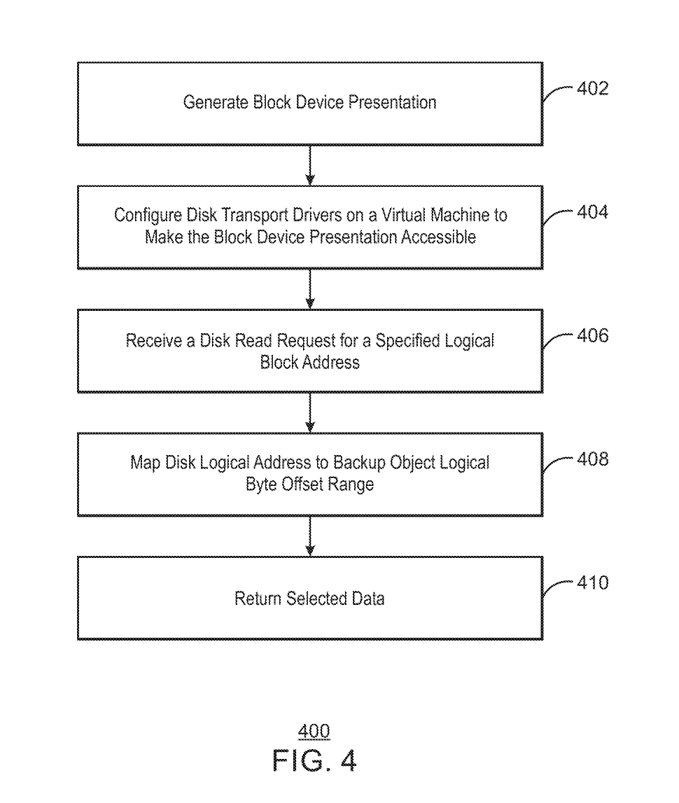

FIG. 4 is a process flow diagram of an example method of restoring data, in accordance with an example implementation of the present techniques. The method is referred to by the reference number 400, and is described in reference to the system of FIG. 2.

The method begins at block 402, wherein virtual machine 124 generates a block device presentation 220. The block device presentation 220 can correspond to one or more snapshots 230, 232 to be restored.

At block 404, the virtual machine 124 configures disk transport drivers 214 on a virtual machine 124 to make the block device presentation 220 accessible. In some examples, the drivers 214 are configured dynamically. For example, the drivers 214 can be configured upon receiving a restore request from a target server 104. In some examples, a modified set of iSCSI or FC drivers are configured for FC connectivity. Once the drivers 214 are configured, one or more clients can access a GUI 206 to select a snapshot 230, 232 or byte range of a snapshot 230, 232 to restore.

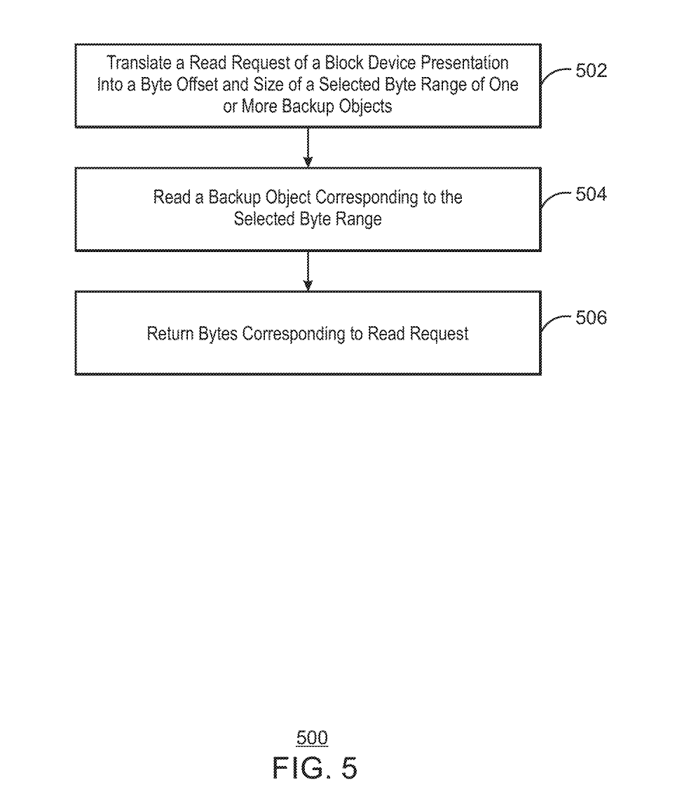

At block 406, the virtual machine 124 receives a disk read request for a specified logical block address. The virtual machine 124 can receive the read request and convert the read request to a byte size and offset as discussed in FIG. 5 below. The virtual machine 124 can then request selected data from one or more backup objects 240 corresponding to the requested byte range. The virtual machine 124 can use a data map 242 to determine which backup objects or portion of one or more backup objects correspond to a particular byte range.

At block 408, the virtual machine 124 maps a disk logical address to a backup object logical byte offset range. For example, the virtual machine 124 can use the data map 328 to map the disk logical address as discussed in FIG. 5 below.

At block 410, the virtual machine 124 returns selected data corresponding to the specified logical block address to a target storage device. In some examples, the virtual machine uses the data map to return selected data from backup objects 240 from the object store 238 in an order corresponding to a snapshot 230 or a portion thereof as discussed in detail with reference to FIG. 5 below. In some examples the virtual machine returns a portion of a backup object 240 from the object store 238 corresponding to the specified logical block address.

In some examples, the virtual machine 124 removes the block device presentation 220 from the virtual machine. The client can unmount the block device presentation 220 after restoration and the virtual machine 124 can delete the block device presentation 220. Thus, the disk resources used for the block device presentation 220 can be freed for use by other system components and processes.

The process flow diagram of FIG. 4 is not intended to indicate that the operations of the method 400 are to be executed in any particular order, or that all of the operations of the method 400 are to be included in every case. For example, the configuration of transport drivers in block 404 can be executed before the generation of a block device presentation in block 402. Additionally, the method 400 can include any suitable number of additional operations.

FIG. 5 is a process flow diagram of an example method of restoring data using a block device presentation 220, in accordance with an example implementation of the present techniques. The method is referred to by the reference number 500, and is described in reference to the example system of FIG. 3.

The method begins at block 502, wherein a virtual machine translates a read request of a block device presentation 220 into a byte offset and size of a selected byte range of one or more backup objects 322, 324, 326. For example, a read request can be in SCSI block command set (SBC) format. The portion of the block device presentation 220 requested by the read request can be translated into a byte offset and size of a portion of one or more backup objects 322, 324, 326. For example, the backup object logical byte offset range can be a sub-range of the backup object 322, 324, 326. In some examples, a data map 328 is used to determine the data offset and size corresponding to the read request.

At block 504, the virtual machine 124 can read a backup object 322 corresponding to the selected byte range 314. For example, the backup object may be one of a plurality of backup objects 322, 324, 326 that comprise a full backup image 338. In some examples, a data map 328 is used to determine the backup object or backup objects 322, 324, 326 corresponding to the selected byte range.

At block 506, the virtual machine 124 returns bytes corresponding to the read request. In some examples, the virtual machine returns the bytes to a target storage device 224. In some examples, the bytes are sent via an iSCSI connection 226. In some examples, the bytes are sent via a Fiber Channel (FC) link 226. For example, bytes corresponding to all or part of the backup objects 322, 324, 326 can be included in a response to the target server 104 in a SBC format.

The process flow diagram of FIG. 5 is not intended to indicate that the operations of the method 500 are to be executed in any particular order, or that all of the operations of the method 500 are to be included in every case. Additionally, the method 500 can include any suitable number of additional operations. For example, the virtual machine 124 can remove the block device presentation 220 after selected data from the backup is restored.

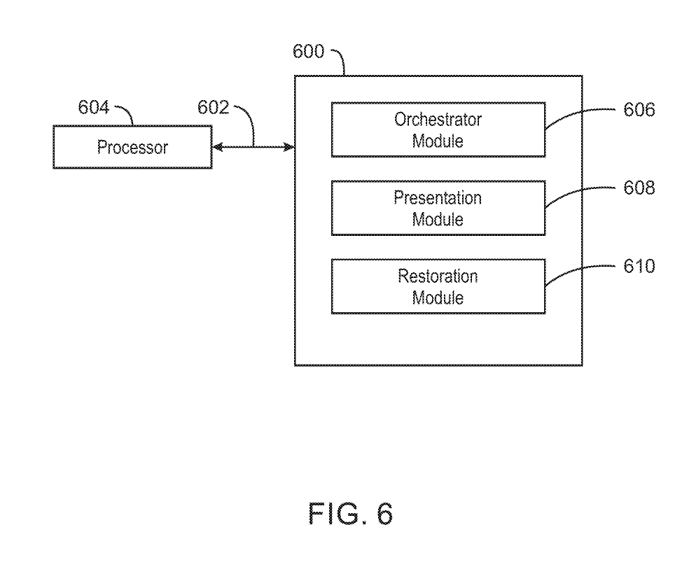

FIG. 6 is a block diagram showing an example non-transitory, machine-readable medium that stores code configured to provide a block device presentation, in accordance with an example implementation of the present techniques. The non-transitory, machine-readable medium is referred to by the reference number 600. The non-transitory, machine-readable medium 600 can comprise RAM, a hard disk drive, an array of hard disk drives, an optical drive, an array of optical drives, a non-volatile memory, a universal serial bus (USB) drive, a digital versatile disk (DVD), a compact disk (CD), and the like. In example implementations, the non-transitory, machine-readable medium 600 is executed on one or more servers in a server cluster. The non-transitory, machine-readable medium 600 can be accessed by a processor 602 over a communication path 604.

As shown in FIG. 6, the various example components discussed herein can be stored on the non-transitory, machine-readable medium 600. A first region 406 on the non-transitory, machine-readable medium 600 can include an orchestrator module 606 that performs backups. The orchestrator module 606 can include code to generate a data map between a snapshot space and a backup object space. For example, the snapshot space can include a snapshot virtual volume and a corresponding base virtual volume. A backup object space can include a plurality of deduplicating objects associated with a snapshot stored in an object store of a deduplicating appliance. Another region 608 on the non-transitory, machine-readable medium 600 can include a presentation module 608 that can include code to generate a block device presentation. For example, the block device presentation can be a mountable read-only file system. The presentation module 608 can also include code to dynamically configure a disk transport driver. For example, the presentation module 608 can configure the disk transport driver to allow a snapshot and the contents of its backup to be mounted as a read-only file system and accessible to clients and target servers. The block device presentation can then be used to view the contents of a backup and select a range of the backup for restoration. Another region 610 on the non-transitory, machine-readable medium 600 can include a restoration module 610 that can include code to return a selected data to a target disk from a backup object. The backup object can be one of a plurality of deduplicating objects in an object store of a deduplication appliance. The restoration module 610 can also include code to translate a read request of a block device presentation into a byte offset and size of a byte range corresponding to one or more backup objects using the data map. In some examples, the presentation module 608 also includes code to remove the block device presentation after the restoration module 610 is finished restoring a selected byte range.

Although shown as contiguous blocks, the software components can be stored in any order or configuration. For example, if the computer-readable medium 600 is a hard drive, the software components can be stored in non-contiguous, or even overlapping, sectors.

The present techniques are not restricted to the particular details listed herein. Indeed, it may appreciated that many other variations from the foregoing description and drawings may be made within the scope of the present techniques. Accordingly, it is the following claims including any amendments thereto that define the scope of the present techniques.

What is claimed is:

1. A system, comprising:
a backup generator to generate a data map between a snapshot space and a backup object space;
a presentation engine to generate a block device presentation; and
a restoration engine to return a selected data of the block device presentation to a target disk from a backup object using the data map.

2. The system of claim 1, the backup object comprising a deduplicating object.

3. The system of claim 1, the block device presentation comprising a mountable image of a snapshot.

4. The system of claim 1, the data map comprising a sequence of byte ranges mapped to one or more backup objects.

5. The system of claim 1, further comprising an application programming interface (API) to return the selected data corresponding to a byte offset and size of the block device presentation from the backup object.

6. A method, comprising:
generating a block device presentation, the block device presentation corresponding to a snapshot to be restored;
configuring disk transport drivers on a virtual machine to make the block device presentation accessible;
receiving a disk read request for a specified logical block address;
mapping a disk logical address to a backup object logical byte offset range; and
returning a selected data corresponding to the specified logical block address to a target storage device.

7. The method of claim 6, further comprising removing the block device presentation from the virtual machine.

8. The method of claim 6, returning selected data comprising:
translating a read request of the block device presentation into a byte offset and size of a backup object;
read the backup object corresponding to the selected byte range; and
return bytes corresponding to the read request to the target storage device.

9. The method of claim 8, wherein the backup object is to be open for reading, such that the selected data can be read from the backup object.

10. The method of claim 6, wherein the disk transport drivers are to be configured dynamically.

11. A non-transitory machine-readable storage medium encoded with instructions executable by a processor, the machine-readable storage medium comprising instructions to:
generate a data map between a snapshot space and a backup object space;
generate a block device presentation; and
return a selected data to a target disk from a backup object using the block device presentation.

12. The non-transitory machine-readable storage medium of claim 11, further comprising instructions to remove the block device presentation.

13. The non-transitory machine-readable storage medium of claim 11, wherein the backup object comprises a deduplicating object.

14. The non-transitory machine-readable storage medium of claim 11, the instructions to restore the selected data further comprising instructions to translate a read request of a block device presentation into a byte offset and size of a byte range of the backup object using the data map.

15. The non-transitory machine-readable storage medium of claim 11, further comprising instructions to dynamically configure a disk transport driver.
